(19) United States
(12) Patent Application Publication
(10) Pub. No.: US 2012/0098942 A1
(43) Pub. Date: Apr. 26, 2012

(54) Frame Rate Conversion For Stereoscopic Video

(76) Inventors: Thomas John Meyer, Mercerville, NJ (US); Kenneth Vavreck, Langhorne, PA (US)

(21) Appl. No.: 12/912,366

(22) Filed: Oct. 26, 2010

(51) Int. Cl. H04N 13/02

(52) U.S. Cl. 348/51; 348/E13.075

(57) ABSTRACT

At least a method and a system are described for providing frame rate conversion using parallax information. In a representative embodiment, the method comprises receiving a frame of stereoscopic video. The stereoscopic video comprises frames for displaying to a left eye and to a right eye. The method comprises computing displacements for a plurality of groups of pixels, wherein each of the groups corresponds to an object of a plurality of objects. The method further comprises using the plurality of displacements to position the plurality of groups within an interpolated frame.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Frame rate conversion is becoming increasingly important for use in LCD based displays, large screen TVs, and handheld devices. However, the manner in which the frame rate conversion is performed may affect the quality of the resulting video. For example, when the frame rate is upconverted, one or more interpolated frames are generated. If the interpolation is not performed correctly, various moving objects may be occluded from view. For example, a moving object such as a baseball may be improperly occluded by a stationary object such as a tree when, in fact, it should be positioned in front of the tree. As a result, the resulting video may contain artifacts which may be undesirable to a viewer.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a method and a system of providing frame rate conversion by way of using parallax information from one or more groups of pixels corresponding to one or more displayed objects. The parallax information is obtained from left and right frames of stereoscopic video.

The various aspects and representative embodiments of the method and system are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a diagram that illustrates the generation of interpolated frames between two adjacent input frames (original frames) in accordance with an embodiment of the invention.

FIG. 2 is a diagram which illustrates how parallax information is used to generate an interpolated frame in accordance with an embodiment of the invention.

FIG. 3 illustrates the computation of parallax and the use of parallax in determining the distance of one or more objects from a viewer (or camera) in accordance with an embodiment of the invention.

FIG. 4 is a block diagram of a system used in performing frame rate conversion for left and right video streams of stereoscopic video in accordance with an embodiment of the invention.

FIG. 5 illustrates horizontal displacement computations for a group of pixels centered at a particular pixel location on a display when the displacement computation is performed for a left stream and for a right stream in accordance with an embodiment of the invention.

FIG. 6 is an operational flow diagram that describes a method of performing frame rate conversion in accordance with an embodiment of the invention.

### DETAILED DESCRIPTION OF THE INVENTION

Various aspects of the invention can be found in a method and a system of performing a frame rate conversion (FRC). In accordance with the various aspects of the invention, interpolated frames are generated when performing frame rate conversion of video. The interpolation may be performed on any video stream to attain a higher output rate. In a representative embodiment, the interpolation is performed on a stereoscopic (or 3-D) video stream. The stereoscopic video stream may comprise a pair of video streams—one stream for the left eye and another stream for the right eye. Thus, for each frame period, a 3-D or stereoscopic video stream comprises a left frame and a right frame.

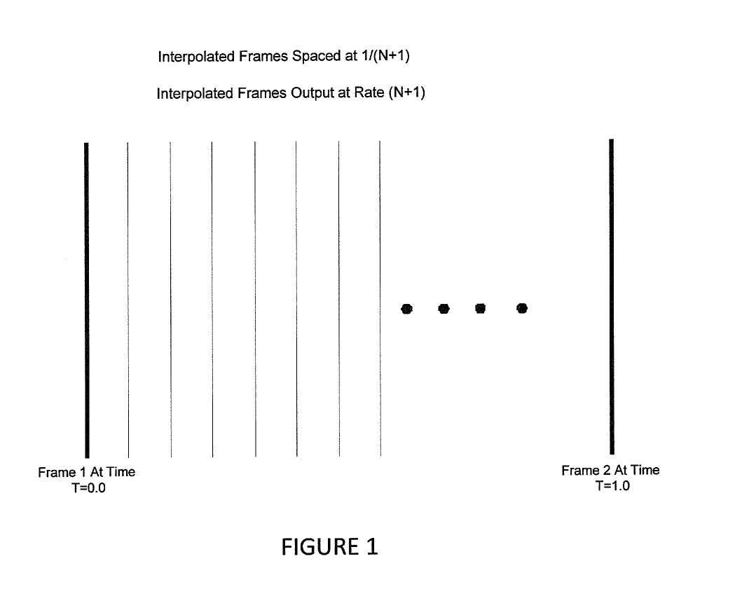

FIG. 1 is a diagram that illustrates the generation of interpolated frames between two adjacent input frames (original frames) in accordance with an embodiment of the invention. The input frames may correspond to any received video stream. The video stream may be provided by a provider such as a cable operator, for example. FIG. 1 illustrates two successive (or adjacent) input frames (Frame 1 and Frame 2) generated at times T=0.0 and T=1.0 seconds. Also illustrated in FIG. 1 are N interpolated frames, located between the two successive frames, which are spaced out at every 1/(N+1) seconds. Thus, in this embodiment, N+1 interpolated frames are generated for each input period. For example, in the case where the frame rate is to be upconverted from 24 Hz to 120 Hz, the input period equals 1/24 seconds while the output period is 1/120 seconds. Therefore, N+1=(120/24)=5 and the number of interpolated frames, N equals 4. To simplify the explanation, one may normalize the input frame rate to 1.0 Hz by assuming that the input frame rate is 1.0 Hz (i.e., 24 Hz/24) while the output frame rate is 5.0 Hz (i.e., 120 Hz/24). Thus, two consecutive input frames are received at times 0.0 and 1.0 seconds while it is desired to produce output frames at times, 0.2, 0.4, 0.6, and 0.8 seconds. Thus, in this example, the number of interpolated frames is equal to 4 (i.e., N=4). In accordance with the various aspects of the invention, the received video stream comprises stereoscopic or 3-D video stream, in which frame rate conversion is performed on each of a left and a right video stream of the stereoscopic video. The stereoscopic (3-D) video stream comprises two independent streams—the left stream is for displaying to the left eye while the right stream to for displaying to the right eye.

When interpolating the stereoscopic video, the various aspects of the invention may utilize parallax information of one or more displayed objects since the one or more objects presented by the left video stream are viewed from the perspective of a person's left eye while the one or more objects presented by the right video stream are viewed from the perspective of a person's right eye. The apparent visual difference in the position of each object is used to assist in the positioning of an object relative to other objects when generating an interpolated frame in the frame rate conversion process. In accordance with the various aspects of the invention, this parallax information is used by a circuitry (i.e., which may be described as a motion estimation circuitry hereinafter) to generate and output an appropriate motion vector for use by either a left video stream frame rate converter or right video stream frame converter. Thus, the parallax information may be used to determine the relative positions of different objects in an interpolated frame. For example, the parallax may be utilized to determine if a particular moving object such as a baseball is to be positioned behind or in front of another object such as a tree in the interpolated frame.

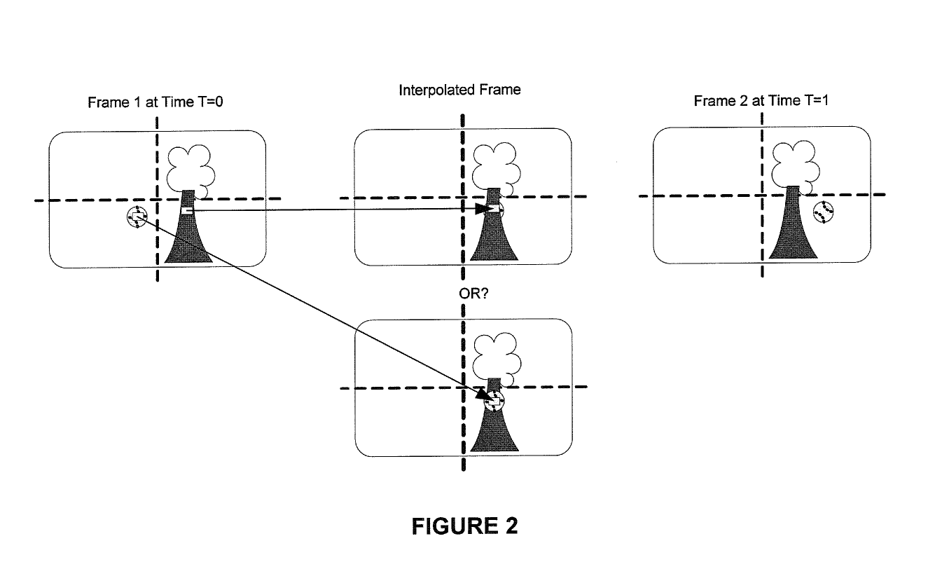

FIG. 2 is a diagram which illustrates how parallax information is used to generate an interpolated frame in accordance with an embodiment of the invention. For example, FIG. 2 illustrates a situation in which a baseball travels from left to right across the display from time T=0 to time T=1. As illustrated, an interpolated frame is to be generated between two successive frames. Although not shown in FIG. 2, in alternate embodiments, more than one interpolated frame may be generated between the two successive frames. The pre-processed stereoscopic video comprises a sequence of left and right frames. For example, two consecutive frames of a left video stream or right video stream are shown in FIG. 2, in which a first frame (left or right) is generated at time T=0, and a second frame (left or right) is generated at time T=1, while the interpolated frame (left or right) is generated between these two times. As indicated in FIG. 2, the position or location of a baseball is determined for the interpolated frame. As indicated in FIG. 2, the baseball may be positioned in front of the tree or may be positioned behind the tree. To determine whether the baseball is in front of the tree or behind the tree, parallax information at time T=0, for example, may be obtained from a stereoscopic frame. Since a stereoscopic frame comprises a left frame and a right frame, one may compute the parallax or horizontal displacement of the baseball and the horizontal displacement of the tree between the left and right frames. This parallax or displacement information may be used to determine the relative distances of objects, such as the baseball and the tree, from the camera or viewer. The relative distances of various objects from the camera are important when generating the various objects within an interpolated frame. The various aspects of the invention utilize the parallax or displacement information to properly position one or more objects in an interpolated frame.

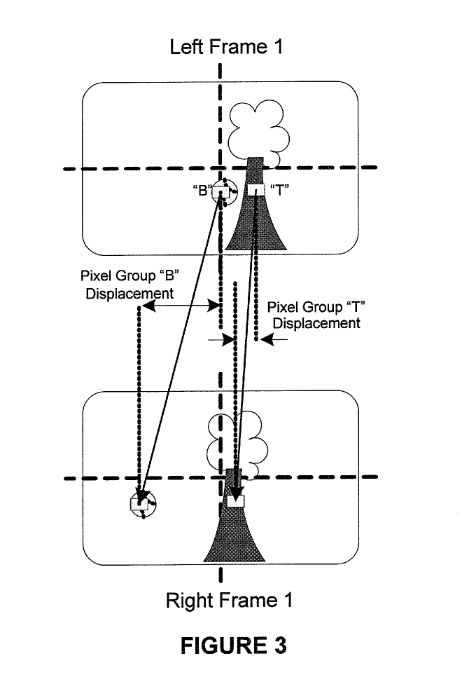

FIG. 3 illustrates the computation of parallax and the use of parallax in determining the distance of one or more objects from a viewer (or camera) in accordance with an embodiment of the invention. FIG. 3 illustrates the horizontal displacement of the baseball and the horizontal displacement of the tree when comparing the left frame and the right frame for frame 1 of a stereoscopic video stream. The left frame for frame 1 is shown on top of FIG. 3 while the right frame for frame 1 is shown on the bottom of FIG. 3. As illustrated, the pixels associated with the baseball have a greater horizontal displacement compared to the pixels associated with the tree. Therefore, based on this parallax or displacement information, the baseball is considered closer to the viewer than the tree. As a consequence, any pixels associated with the baseball would be positioned in front of any pixels associated with the tree when an interpolated frame is generated. Based on this parallax information, motion vectors for one or more objects (e.g., baseball, tree, etc.) may be generated by the previously mentioned motion estimation circuitry for use by a frame rate converter to appropriately position the pixels associated with one or more objects in the interpolated frame. Thus, the various aspects of the invention may utilize parallax in determining a plurality of motion vectors associated with a plurality of pixel groups of a frame. Each of the pixel groups may correspond to an object displayed in the frame. For example, each group of pixels may correspond to a particular object in the frame. FIG. 3 illustrates the displacements associated with a first group of pixels corresponding to a baseball and a second group of pixels corresponding to a tree. In the interpolation of a frame, the motion estimation circuitry may identify an object and then group a number of pixels corresponding to that object. The object may be moving such as a thrown baseball, for example. The image provided by a left or right frame (in 3-D or stereoscopic video) may display a number of objects which may be stationary or moving. A motion vector for each group of pixels may be computed by hardware and/or software, such as the previously mentioned motion estimation circuitry. To determine a motion vector, the motion estimation circuitry may execute an algorithm that utilizes the parallax information previously described. For each group of pixels, numerous candidate motion vectors may be computed and analyzed by the motion estimation circuitry. However, when generating an interpolated frame, it may not be obvious which motion vector to choose, particularly in cases where the group of pixels corresponding to the moving object could be interpolated as being positioned behind or in front of another object. This is particularly true in cases of occlusion such as where a baseball may travel in front or behind of another object such as a stationary tree. The frame rate converter may utilize displacement or parallax information previously described in order to determine the appropriate motion vector that is used for each group of pixels corresponding to an object of one or more objects in a left or right frame.

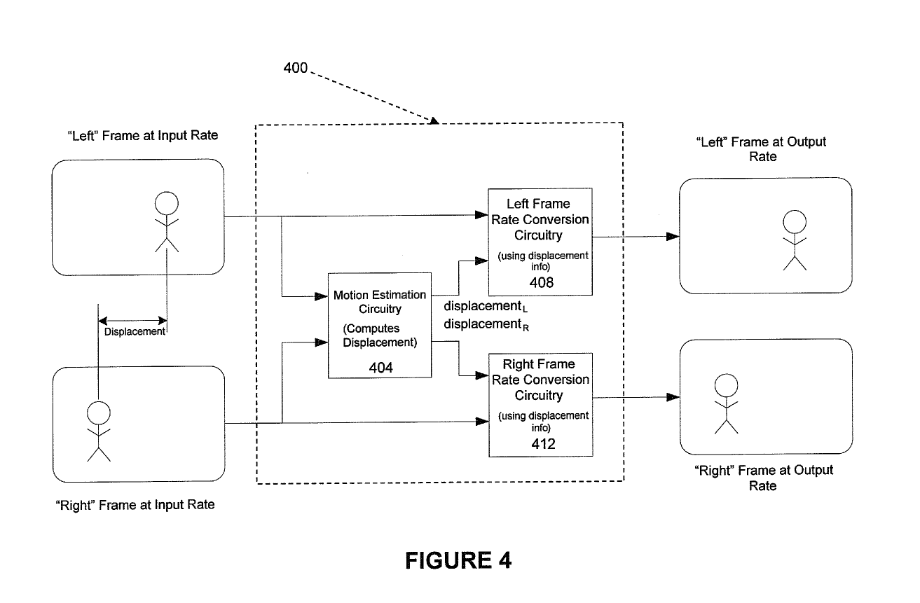

FIG. 4 is a block diagram of a system 400 used in performing frame rate conversion for left and right video streams of stereoscopic video in accordance with an embodiment of the invention. As shown, the system 400 receives left and right video streams of a stereoscopic video stream. As illustrated, each of the left and right frames may display an object, such as a person, for example, which appears displaced between the left and right frames since the object is positioned relative to two different lines of sight. The left and right video streams provide inputs to the motion estimation circuitry 404, the left frame rate conversion circuitry 408, and the right frame rate conversion circuitry 412. At a particular frame time, the motion estimation circuitry 404 extracts the parallax or displacement information for one or more objects from the left and right frames. Corresponding left and right images are processed using a motion estimation algorithm employed by the motion estimation circuitry 404. The algorithm determines the displacement between an object of one or more objects between the two images. In a representative embodiment, the displacement may be constrained to the horizontal direction which would simplify the computations performed by the motion estimation circuitry 404. The displacement information may be transmitted to a left frame rate conversion circuitry and/or a right frame rate conversion circuitry where further processing of the image occurs. The left frame rate conversion circuitry and right frame rate conversion circuitry may compute the distance an object is from the camera based on the following equation:

Distance=α(1/displacement), where α is a constant.

The foregoing equation indicates that the distance of an object is inversely proportional to its displacement. It should be noted that it is not necessary to know the constant, α, in the foregoing equation because the intention is to determine the relative distances between various objects from the camera. The left frame rate conversion circuitry 408 and the right frame rate conversion circuitry 412 may use this relative distance information to properly generate the objects displayed in an interpolated frame. The motion estimation circuitry 404 may comprise hardware and/or software for generating the algorithm. The motion estimation circuitry 404 may comprise a processor and memory in which the memory may store the software. The processor may execute the software to generate the algorithm. The left frame rate conversion circuitry 408 and right frame rate conversion circuitry 412 utilize the motion vectors or displacement information to generate interpolated frames. The left frame rate conversion circuitry 408 generates a left interpolated frame while the right frame rate conversion circuitry 412 generates a right interpolated frame. As illustrated in FIG. 4, the frame rate conversion circuitries 408, 412 provide left and right interpolated frame outputs which are displayed to a viewer. Based on the output rate desired, one or more interpolated frames are generated between successive input frames. The frame rate conversion circuitries 408, 412 may comprise any type of hardware and/or software for processing the received left and right video streams using the motion vectors or displacement information provided by the motion estimation circuitry 404. In an alternate embodiment, either a left frame conversion circuitry 408 or a right frame conversion circuitry 412 may be used such that interpolation may be performed on non-stereoscopic video.

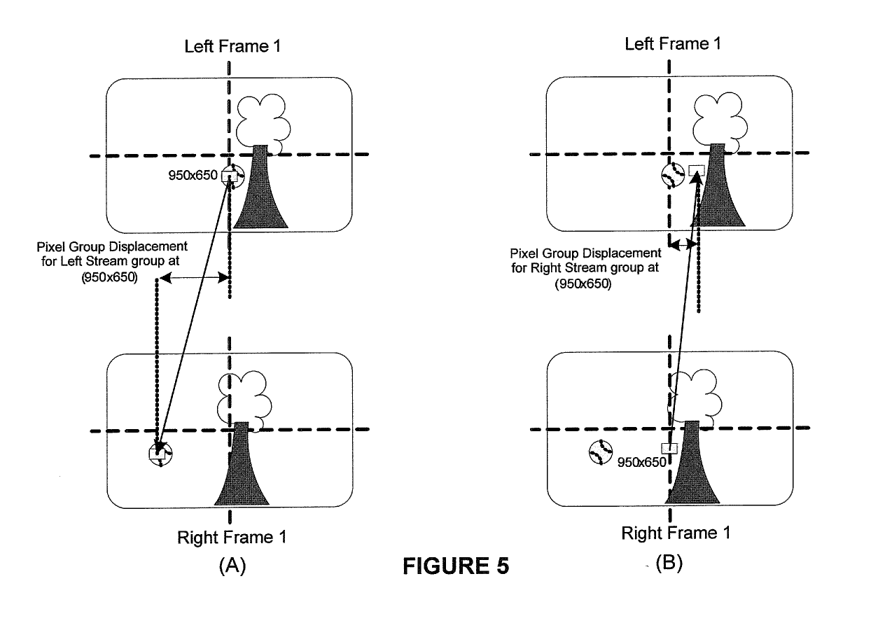

FIG. 5 illustrates horizontal displacement computations for a group of pixels centered at a particular pixel location on a display when the displacement computation is performed for a left video stream and for a right video stream of stereoscopic video in accordance with an embodiment of the invention. The left and right video streams may be considered independent of each other and frames may be interpolated separately for each stream using the left frame rate conversion circuitry 408 and the right frame rate conversion circuitry 412. The displacement computation for left and right streams may include common computations which may be combined into a single process. However, the displacement computations for the left stream may not necessarily be the same for the right stream, as illustrated in FIG. 5. The displacement computation for the left stream does not simply consist of negated displacement values obtained from the right stream as demonstrated in FIG. 5. The displacement obtained for a group of pixels starting from location 950×650 in the left stream (see FIG. 5A) produces a different result compared to the group of pixels starting from the same location in the right stream (see FIG. 5B). Thus, based on whether the displacement is computed relative to the left stream or relative to the right stream, the displacement computations for the left stream and right stream may be performed separately by the motion estimation circuitry previously shown in FIG. 4.

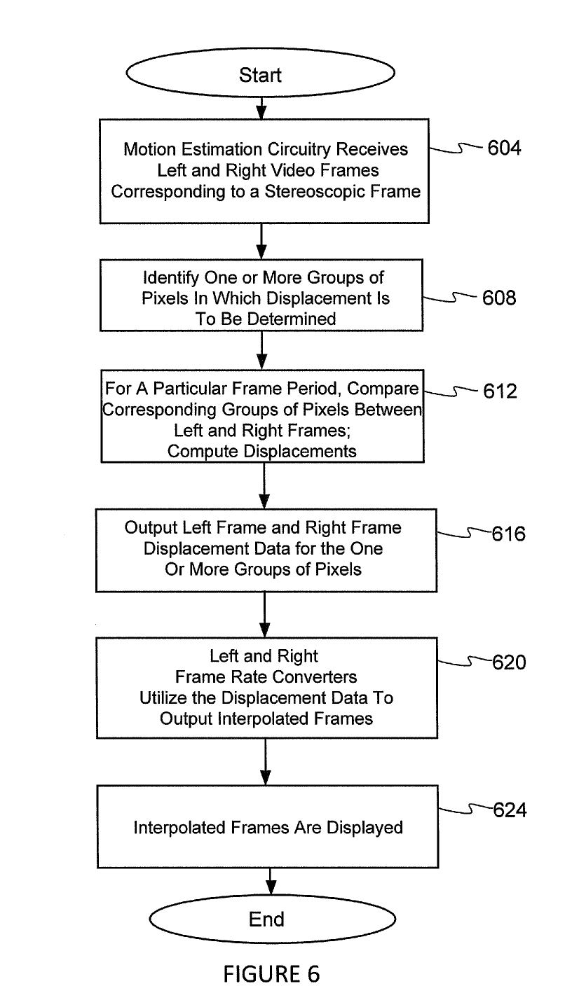

FIG. 6 is an operational flow diagram that describes a method of performing frame rate conversion in accordance with an embodiment of the invention. In a representative embodiment, the output display rate is upconverted by way of generating one or more interpolated frames. In a representative embodiment, the up-conversion is performed on a received stereoscopic video (or 3-D video). The stereoscopic video comprises a pair of video streams. One stream of the pair comprises a left video stream (for display to a person's left eye) while the other stream of the pair comprises a right video stream (for display to a person's right eye). At step 604, the motion estimation circuitry receives left and right video streams corresponding to the received stereoscopic video. Each of the left and right video streams comprises one or more frames. The motion estimation circuitry identifies one or more groups of pixels in a frame in which one or more displacements may be computed. The one or more groups may correspond to one or more objects within the displayed image. At step 612, the parallax or displacement for a particular group of pixels may be computed for a frame relative to a left video stream or for a frame relative to a right video stream. The parallax may be determined by way of determining the change in location or position of that group of pixels between its left frame and its corresponding right frame. For a frame originating from the left stream, the displacement is computed relative to its left frame. For a frame originating from the right stream, the displacement is computed relative to its right frame. The motion estimation circuitry may perform these types of displacement computations for a plurality of groups of pixels. Each group of pixels may correspond to a particular object in an image displayed by a left or right frame of the stereoscopic video. A circuitry such as the previously mentioned motion estimation circuitry may be used to compute the displacements. The circuitry may comprise hardware and/or software for computing the displacements, for example. Next, at step 616, the left and/or right displacements are output to a left frame rate conversion circuitry and/or a right frame rate conversion circuitry. The left and/or right displacements may be output as left and/or right motion vectors. The left and right displacements may be output as corresponding motion vectors to the left and right frame rate conversion circuitries. Thereafter, at step 620, a left frame rate converter utilizes left frame displacement information to output an interpolated frame for a left frame. Likewise, a right frame rate converter utilizes right frame displacement information to output an interpolated frame for a right frame. Based on the displacements or motion vectors, the frame rate conversion circuitries may properly position each group of pixels in front of another group of pixels or behind another group of pixels, for example. Depending on the desired output rate, one or more interpolated frames may be generated by the left and/or right frame rate conversion circuitries. Next, at step 624, the right and left interpolated frames are displayed on a display capable of displaying stereoscopic or 3-D video. As previously described in connection with FIG. 4, the output provided by either the left frame conversion circuitry or the right frame conversion circuitry may be used to display non-stereoscopic video such as two-dimensional video. Therefore, the aforementioned steps may be performed by way of using either the left or right frame rate converter when non-stereoscopic video such as two-dimensional (2-D) video, for example, is to be displayed. One or more interpolated frames may be generated successively based on the desired output frame rate. The foregoing process may be repeated for each pair of left and/or right input frames of the received stereoscopic video.

The various aspects of the present invention may be realized in the form of hardware, software, or a combination thereof. The hardware may comprise one or more circuits, for example. Furthermore, the present invention may be realized using any kind of computer system or other apparatus adapted for carrying out the methods described herein. A typical combination of hardware and software may comprise a general-purpose computer system with a computer program that, when being loaded and executed, may control the computer system such that it executes the methods described herein. The general-purpose computer system may comprise one or more processors and memory for storing the computer program. The present invention may also be embedded in a computer program product, which comprises all the features enabling the implementation of the methods described herein, and which when loaded in a computer system is able to execute these methods. Program in the present context means any expression, in any language, code or notation, of a set of instructions intended to cause a system having an information processing capability to perform particular functions either directly or after either or both of the following: a) conversion to another language, code or notation; b) reproduction in a different material form.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of performing frame rate conversion of video by way of generating one or more interpolated frames comprising:
receiving a left video frame and a right video frame, said left video frame for displaying to a left eye, said right video frame for displaying to a right eye;
computing a plurality of displacements for a plurality of groups of pixels, each of said groups corresponding to an object of a plurality of objects, wherein each of said displacements is based on comparing the position of said each of said groups between said left frame and said right frame; and
using said plurality of displacements to position said plurality of groups within an interpolated frame of said one or more interpolated frames.

2. The method of claim 1 wherein each of said plurality of displacements are computed relative to said left video frame and wherein said interpolated frame is for said left eye.

3. The method of claim 1 wherein each of said plurality of displacements are computed relative to said right video frame and wherein said interpolated frame is for said right eye.

4. The method of claim 1 wherein a first group of pixels of said plurality of groups occludes a second group of pixels of said plurality of groups.

5. The method of claim 1 wherein a first group of pixels of said plurality of groups is positioned in front of a second group of pixels of said plurality of groups.

6. The method of claim 1 wherein said frame rate is upconverted by a value equal to the number of interpolated frames plus 1.

7. The method of claim 1 wherein said frame rate of said video is upconverted from 24 Hz to 120 Hz.

8. The method of claim 1 wherein said video comprises stereoscopic video.

9. A system for performing frame rate conversion of video by way of generating one or more interpolated frames comprising:
one or more circuits operable for, at least:
receiving a left video frame and a right video frame, said left video frame for displaying to a left eye, said right video frame for displaying to a right eye;
computing a plurality of displacements for a plurality of groups of pixels, each of said groups corresponding to an object of a plurality of objects, wherein each of said displacements is based on comparing the position of said each of said groups between said left frame and said right frame; and
using said plurality of displacements to position said plurality of groups within an interpolated frame of said one or more interpolated frames.

10. The system of claim 9 wherein each of said plurality of displacements are computed relative to said left video frame and wherein said interpolated frame is for said left eye.

11. The system of claim 9 wherein each of said plurality of displacements are computed relative to said right video frame and wherein said interpolated frame is for said right eye.

12. The system of claim 9 wherein a first group of pixels of said plurality of groups occludes a second group of pixels of said plurality of groups.

13. The system of claim 9 wherein a first group of pixels of said plurality of groups is positioned in front of a second group of pixels of said plurality of groups.

14. The system of claim 9 wherein said frame rate is upconverted by a value equal to the number of interpolated frames plus 1.

15. The system of claim 9 wherein said frame rate of said video is upconverted from 24 Hz to 120 Hz.

16. The system of claim 9 wherein said video comprises stereoscopic video.

17. A method comprising:
receiving stereoscopic video comprising:
a left video stream for display to a left eye; and
a right video stream for display to a right eye;
computing parallax of a plurality of groups of pixels corresponding to a plurality of objects using a corresponding pair of frames obtained from said left video stream and said right video stream; and
using said parallax to position said plurality of groups of pixels within an interpolated frame, said interpolated frame generated during a frame rate upconversion.

18. The method of claim 17 wherein said parallax of said plurality of groups of pixels is computed relative to a left frame of said pair of frames and wherein said interpolated frame is for said left eye.

19. The method of claim 17 wherein said parallax of said plurality of groups of pixels is computed relative to a right frame of said pair of frames and wherein said interpolated frame is for said right eye.

20. The method of claim 17 wherein said frame rate is upconverted by a value equal to the number of interpolated frames plus 1.

21. The method of claim 17 wherein said frame rate of said video is upconverted from 24 Hz to 120 Hz.

22. A system comprising:
one or more circuits operable for, at least:
receiving stereoscopic video comprising:
a left video stream for display to a left eye; and
a right video stream for display to a right eye;
computing parallax of a plurality of groups of pixels corresponding to a plurality of objects using a corresponding pair of frames obtained from said left video stream and said right video stream; and
using said parallax to position said plurality of groups of pixels within an interpolated frame, said interpolated frame generated during a frame rate upconversion.

23. The system of claim 22 wherein said parallax of said plurality of groups of pixels is computed relative to a left frame of said pair of frames and wherein said interpolated frame is for said left eye.

24. The system of claim 22 wherein said parallax of said plurality of groups of pixels is computed relative to a right frame of said pair of frames and wherein said interpolated frame is for said right eye.

25. The system of claim 22 wherein said frame rate is upconverted by a value equal to the number of interpolated frames plus 1.

26. The system of claim 22 wherein said frame rate of said video is upconverted from 24 Hz to 120 Hz.
